(19) United States
(12) Patent Application Publication
(10) Pub. No.: US 2026/0218422 A1
(43) Pub. Date: Jul. 30, 2026

(54) RECYCLING METHOD OF WASTE FIBER-REINFORCED COMPOSITE

(71) Applicant: INSTITUTE OF PROCESS ENGINEERING, CHINESE ACADEMY OF SCIENCES, Beijing (CN)

(72) Inventors: Zhimao ZHOU, Beijing (CN); Shifei LI, Beijing (CN)

(21) Appl. No.: 18/878,465

(22) PCT Filed: May 4, 2023
(86) PCT No.: PCT/CN2023/091986

§ 371 Date: Sep. 25, 2025

(30) Foreign Application Priority Data
Jun. 24, 2022 (CN) 202210728742.0

(51) Int. Cl. D01G 11/00; C03C 13/00; C08J 11/14; C08J 11/16

(52) U.S. Cl. CPC D01G 11/00; C03C 13/00; C08J 11/14; C08J 11/16

(57) ABSTRACT

A recycling method of a waste fiber-reinforced composite is provided, including: (1) subjecting the waste fiber-reinforced composite to crushing, then immersion, and then a microwave treatment to obtain a material A; (2) subjecting the material A obtained in step (1) to steam explosion to obtain a material B; and (3) subjecting the material B obtained in step (2) to a chemical treatment to obtain a recycled material.

### TECHNICAL FIELD

The present disclosure pertains to the technical field of material recycling methods, and relates to a recycling method of a waste fiber-reinforced composite.

### BACKGROUND

Fiber-reinforced resin-based composites have been widely used in aerospace, sports equipment, wind turbine blades, building reinforcement, transportation and other fields, especially in the wind turbine blades and photovoltaic substrates, due to their advantages such as light weight, high strength and specific modulus, fatigue resistance, corrosion tolerance, designability, and desirable molding processability. In the next decade, as installed capacity doubles in onshore and offshore wind power, over 33,000 units are also going to be retired, and demand as well as waste for composites of the wind turbine blades may simultaneously grow rapidly in China. The waste of composites for wind turbine blades includes waste generated during the production, such as scraps, expired prepregs, and waste that has reached the end of its service life. Waste from different sources shows different compositions. Waste generally contains impurities such as paper, thermoplastic resins, adhesives, and metals. In addition, the high strength and corrosion tolerance of these materials further increase the difficulty in recycling.

Scientifically recycling the fibers in composites for wind turbine blades has high ecological and economic values, and could not only reduce environmental pollution, but also regenerate waste as secondary resources to alleviate the tremendous pressure of resource depletion. Therefore, it is extremely important and necessary to degrade the composites for wind turbine blades and recycle resulting fibers.

The recycling methods of composites for waste wind turbine blades in related technologies mainly include physical recycling, energy recycling, and chemical recycling. The chemical recycling could obtain high-value fibers and recover resin as materials or energy, and is the most suitable method for processing waste fiber composites. The chemical recycling mainly includes pyrolysis and solvent decomposition depending on whether a medium is used.

Pyrolysis is a process that utilizes high temperatures to decompose the resin in a composite into organic small molecules to recover the fibers. The pyrolysis does not use chemical reagents and is easy to scale up industrially, and is also the only method in the world that could achieve commercial operation of fiber composite recycling. However, the pyrolysis has the disadvantages of large investment, high energy consumption, low performance of recovered products, and high carbon emissions. The solvent method refers to breaking the cross-linking bonds in a polymer by the combined action of solvent and heat, decomposing the polymer into low-molecular-weight polymers or organic small molecules dissolved in the solvent, thereby separating the resin matrix and reinforcer(s). For example, CN113603929A discloses a method for recycling an epoxy resin composite. In the method, a resin is dissolved by using a composite solvent of an imidazole salt or pyridinium salt ionic liquid and a solvent, thereby recycling fibers, and the method has simple experimental procedures, and mild reaction conditions, and results in a product with better performance. Moreover, the composite solvent is environmental-friendly and shows economic benefits. However, the method suffers from a low recovery rate.

Therefore, it is an urgent problem to be solved in the art to develop a recycling method of a waste fiber-reinforced composite with high recovery rate, simple process, and low cost.

### SUMMARY

An overview of the subject matter detailed in the disclosure is provided below, which is not intended to limit the scope of the claims.

The present disclosure provides a recycling method of a waste fiber-reinforced composite. The recycling method combines a mechanical treatment, a microwave treatment, steam explosion, and a chemical treatment to recycle the waste fiber-reinforced composite, and improves a dissolution efficiency of resin(s) and the recycling rate of fibers in a specific process, thereby achieving full resource recovery and high-value utilization of fibers and resin materials. Moreover, the recycling method has the advantages of simple operations, low energy consumption, wide application range, and significant economic and environmental benefits. The present disclosure adopts the following technical solutions.

In a first aspect, the present disclosure provides a recycling method of a waste fiber-reinforced composite, including the following steps:
(1) subjecting the waste fiber-reinforced composite to crushing, then immersion, and then a microwave treatment to obtain a material A;
(2) subjecting the material A obtained in step (1) to steam explosion to obtain a material B; and
(3) subjecting the material B obtained in step (2) to a chemical treatment to obtain a recycled material.

In embodiments of the present disclosure, a matrix resin in the fiber-reinforced composite generally has high hardness and brittleness. The crushing could enlarge surface cracks of the resin and pores at an interface between the resin and the fibers, facilitating the diffusion of the solution in the resin during the immersion. Further, the microwave treatment could promote the solution to enter the resin, accelerate the dissolution of the resin, and also make molecular gaps of the composite as well as the interface between the resin and the fibers filled with high-pressure steam, such that the material becomes soft. In addition, due to the different hygroscopic expansion coefficients of the fibers and the resin matrix, a shear stress is generated at the interface between the fibers and the resin, resulting in cracks. Moreover, the evaporation of water molecules accelerates the interface damage, resulting in a large number of cracks on a surface of the sample. During the subsequent steam explosion, the gas in the air expands rapidly and produces an explosion, such that the interface damage and steam explosion promote each other, resulting in the degradation of the resin matrix and the depolymerization of molecules. The composite after the above treatments is more conducive to the chemical solvent entering the interior of the resin, which accelerates the decomposition and depolymerization of the resin molecules, improves the resin dissolution efficiency, and improves the fiber recovery rate.

In some embodiments, the crushing in step (1) includes at least one selected from the group consisting of crushing by cutting and crushing by using a shredmaster.

In some embodiments, a solution for the immersion in step (1) is one selected from the group consisting of water, an alkaline solution, and an acidic solution, preferably the alkaline solution.

In some embodiments, the alkaline solution and the acidic solution each independently have a mass fraction of 0.1% to 70%, such as 1%, 2%, 4%, 8%, 10%, 20%, 25%, 30%, 35%, 40%, 45%, 50%, 52%, 54%, 56%, 58%, 60%, 62%, 64%, 66%, and 68%.

In some embodiments, a mass ratio of the waste fiber-reinforced composite to the solution during the immersion in step (1) is in a range of 1:2 to 1:10, such as 1:3, 1:3.5, 1:4, 1:4.5, 1:5, 1:5.5, 1:6, 1:6.5, 1:7, 1:7.5, 1:8, 1:8.5, 1:9, and 1:9.5.

In some embodiments, the immersion in step (1) is conducted for 10 min to 120 min, such as 15 min, 20 min, 25 min, 30 min, 35 min, 40 min, 45 min, 50 min, 55 min, 60 min, 65 min, 70 min, 75 min, 80 min, 85 min, 90 min, 95 min, 100 min, 105 min, 110 min, and 115 min.

In some embodiments, the immersion in step (1) is conducted at a temperature of 20° C. to 90° C., such as 25° C., 30° C., 35° C., 40° C., 45° C., 50° C., 55° C., 60° C., 65° C., 70° C., 75° C., 80° C., and 85° C.

In some embodiments, the microwave treatment in step (1) is conducted at a power of 100-2,000 W per kg of the waste fiber-reinforced composite, such as 200 W, 300 W, 400 W, 500 W, 600 W, 700 W, 800 W, 900 W, 1,000 W, 1,100 W, 1,200 W, 1,300 W, 1,400 W, 1,500 W, 1,600 W, 1,700 W, 1,800 W, and 1,900 W, per kg of the waste fiber-reinforced composite. In some embodiments, the microwave treatment in step (1) is conducted at a temperature of 30° C. to 200° C., such as 55° C., 60° C., 65° C., 70° C., 75° C., 80° C., 85° C., 90° C., 95° C., 100° C., 105° C., 110° C., 115° C., 120° C., 125° C., 130° C., 135° C., 140° C., 145° C., 150° C., 155° C., 160° C., 165° C., 170° C., 175° C., 180° C., 185° C., 190° C., and 195° C.

In some embodiments, the microwave treatment in step (1) is conducted for 1 min to 60 min, such as 5 min, 12 min, 14 min, 16 min, 18 min, 20 min, 22 min, 24 min, 26 min, 28 min, 30 min, 34 min, 38 min, 42 min, 44 min, 46 min, 48 min, 50 min, 52 min, 54 min, 56 min, and 58 min.

In some embodiments, a device for the steam explosion in step (2) is a steam explosion reactor.

In some embodiments, the steam explosion in step (2) is conducted at a pressure of 0.2 MPa to 4 MPa, such as 0.4 MPa, 0.6 MPa, 0.8 MPa, 1 MPa, 1.2 MPa, 1.4 MPa, 1.6 MPa, 1.8 MPa, 2 MPa, 2.2 MPa, 2.4 MPa, 2.6 MPa, 2.8 MPa, 3 MPa, 3.2 MPa, 3.4 MPa, 3.6 MPa, and 3.8 MPa, more optionally 1.5 MPa to 3 MPa.

In some embodiments, the steam explosion in step (2) is conducted for 1 min to 20 min, such as 2 min, 4 min, 6 min, 8 min, 10 min, 12 min, 14 min, 16 min, and 18 min.

In some embodiments, the chemical treatment in step (3) is conducted with a chemical solvent.

In some embodiments, the chemical solvent includes at least one selected from the group consisting of an acidic solution, an alkaline solution, a boron halide, an alcohol, and an ionic liquid, more optionally the acidic solution.

In some embodiments, the acidic solution includes at least one selected from the group consisting of sulfuric acid, waste sulfuric acid, formic acid, acetic acid, boric acid, phosphoric acid, nitric acid, hydrofluoric acid, hydrogen peroxide, and hydrochloric acid, and more optionally the sulfuric acid.

In some embodiments, the alcohol includes at least one selected from the group consisting of methanol, ethanol, propanol, butanol, ethylene glycol, and octanol.

In some embodiments, the chemical solvent has a mass fraction not less than 75%, such as 76%, 78%, 80%, 82%, 84%, 86%, 88%, 90%, 92%, 94%, 96%, and 98%.

In some embodiments, a mass ratio of the material B to the chemical solvent in step (3) is in a range of 1:2 to 1:100, such as 1:2, 1:2.5, 1:3, 1:3.5, 1:4, 1:4.5, 1:5, 1:5.5, 1:6, 1:6.5, 1:7, 1:7.5, 1:8, 1:8.5, 1:9, 1:9.5, 1:10, 1:10.5, 1:11, 1:11.5, 1:12, 1:12.5, 1:13, 1:13.5, 1:15, 1:22, 1:24, 1:26, 1:28, 1:30, 1:32, 1:34, 1:36, 1:38, 1:40, 1:42, 1:44, 1:46, 1:48, 1:50, 1:52, 1:54, 1:56, 1:58, 1:60, 1:64, 1:68, 1:72, 1:76, 1:80, 1:84, 1:88, 1:92, 1:96, and 1:98, more optionally 1:(2-13.5).

In examples of the present disclosure, a desirable recovery efficiency could be achieved by using fewer chemical reagents by a specific treatment process, thereby avoiding the use of a large amount of chemical reagents, reducing costs, and reducing the difficulty in recovering chemical reagents.

In some embodiments, the chemical treatment in step (3) further includes mixing the material B with the chemical solvent, and heating.

In some embodiments, the heating includes microwave heating.

In some embodiments, the microwave heating is conducted at a temperature of 80° C. to 200° C., such as 85° C., 90° C., 95° C., 100° C., 105° C., 110° C., 115° C., 120° C., 125° C., 130° C., 135° C., 140° C., 145° C., 150° C., 155° C., 160° C., 165° C., 170° C., 175° C., 180° C., 185° C., 190° C., and 195° C.

In some embodiments, the microwave heating is conducted for 5 min to 300 min, such as 10 min, 20 min, 40 min, 80 min, 100 min, 120 min, 140 min, 180 min, 200 min, 220 min, 240 min, 260 min, and 280 min.

In some embodiments, the microwave heating is conducted at a power of 10-1,500 W per kg of the material B, such as 10 W, 20 W, 40 W, 60 W, 80 W, 100 W, 200 W, 300 W, 400 W, 500 W, 600 W, 700 W, 800 W, 900 W, 1,000 W, 1,100 W, 1,200 W, 1,300 W, and 1,400 W, more optionally 300-600 W per kg of the material B.

In some embodiments, the fiber-reinforced composite includes at least one selected from the group consisting of a carbon fiber-reinforced composite, a glass fiber-reinforced composite, and a basalt fiber-reinforced composite.

In some embodiments, a matrix resin in the fiber-reinforced composite includes at least one selected from the group consisting of a thermosetting resin and a thermoplastic resin.

In some embodiments, the matrix resin includes at least one selected from the group consisting of epoxy resin, polyurethane resin, silicone resin, unsaturated polyester resin, melamine formaldehyde resin, polyimide resin, phenolic resin, and urea formaldehyde resin.

As an optional technical solution of the present disclosure, the recycling method includes the following steps:
(1) subjecting the waste fiber-reinforced composite to the crushing, then the immersion in a solution at a temperature of 20° C. to 90° C. for 10 min to 120 min, and then the microwave treatment at a power of 10-2,000 W per kg of the waste fiber-reinforced composite and a temperature of 30° C. to 200° C. for 10 min to 60 min to obtain the material A, where a mass ratio of the waste fiber-reinforced composite to the solution is in a range of 1:2 to 1:10;
(2) subjecting the material A obtained in step (1) to the steam explosion at a pressure of 0.2 MPa to 4 MPa for 1 min to 20 min to obtain the material B; and
(3) mixing the material B obtained in step (2) with the chemical solvent having the mass fraction not less than 75% and then subjecting a resulting mixture to microwave heating at a power of 10-1,500 W per kg of the material B and a temperature of 80° C. to 200° C. for 5 min to 300 min to obtain the recycled material, where a mass ratio of the material B to the chemical solvent is in a range of 1:2 to 1:100.

A numerical range described in the present disclosure includes not only the point values listed above, but also any point values between the above numerical ranges that are not listed. Due to space limitations and for the sake of simplicity, the present disclosure will no longer exhaustively list the specific point values included in the range.

Some embodiments of the present disclosure have the following beneficial effects:

The present disclosure provides a recycling method of a waste fiber-reinforced composite. The recycling method utilizes mechanical treatment to increase cracks and pores of the resin material, and then utilizes microwave treatment and steam explosion to further enlarge the cracks and pores of the resin material and gaps between the resin and the fibers, thus promoting the solvent to enter the resin to break the bonds and dissolve the resin molecules. Finally, by combining microwave treatment and chemical treatment, the fibers and resin material are quickly separated, the reaction steps are reduced, and the energy consumption is lowered. Therefore, the recycling method realizes the resource recycling of fiber-reinforced composites at low cost and improves the fiber recycling efficiency. Moreover, the recycling method is simple to operate, has low energy consumption, and shows a wide application range, thus exhibiting significant economic and environmental benefits.

Other aspects of the present disclosure are understandable upon reading and understanding of the detailed description.

### DETAILED DESCRIPTION OF THE EMBODIMENTS

The technical solutions of the present disclosure will be further described below through specific examples. Those skilled in the art should understand that these examples only help understand the present disclosure and should not be regarded as specific limitations to the present disclosure.

### Example 1

This example provided a recycling method of a waste fiber-reinforced composite, consisting of the following steps:
(1) A fiber-reinforced composite of waste wind turbine blades was cut into 100 cm pieces, and then crushed into 10 cm to 20 cm pieces by a double-shaft shredmaster, and a 1% by mass sodium hydroxide solution was added thereto, and the immersion was conducted at 50° C. for 60 min, where a mass ratio of the pieces to the sodium hydroxide solution was 1:8, followed by microwave treatment at 1,200 W and 100° C. for 20 min, to obtain a material A.
(2) The material A obtained in step (1) was placed into a 100 L steam explosion reactor and treated at a pressure of 3 MPa for 10 min, followed by filtering to obtain a solid material B, and a filtrate which was recycled and used in step (1).
(3) The solid material B obtained in step (2) was added into a concentrated sulfuric acid solution with a mass fraction of 98% (a mass ratio of the solid material B to the concentrated sulfuric acid solution was 1:8), and a resulting mixture was subjected to microwave heating at 100° C. and 500 W for 50 min, followed by filtration, to obtain fibers and organic waste acid.

### Example 2

This example provided a recycling method of a waste fiber-reinforced composite, consisting of the following steps:
(1) A fiber composite of waste wind turbine blades was cut into 100 cm pieces, and crushed into 10 cm to 20 cm pieces by a double-shaft shredmaster, and a 5% by mass sodium hydroxide solution was added thereto, and the immersion was conducted at 30° C. for 120 min, where a mass ratio of the pieces to the sodium hydroxide solution was 1:5; and a resulting mixture was then subjected to microwave treatment at 1,500 W and 150° C. for 40 min to obtain a material A.
(2) The material A obtained in step (1) was placed into a 100 L steam explosion reactor and treated at a pressure of 2.5 MPa for 15 min, followed by filtering to obtain a material B, and a filtrate which was recycled and used in step (1).
(3) The material B obtained in step (2) was added into a concentrated sulfuric acid solution with a mass fraction of 90% (a mass ratio of the material B to the concentrated sulfuric acid solution was 1:2), and a resulting mixture was subjected to microwave heating at 80° C. and 400 W for 60 min, followed by filtration, to obtain fibers and organic waste acid.

### Example 3

This example provided a recycling method of a waste fiber-reinforced composite, consisting of the following steps:
(1) A fiber composite of waste wind turbine blades was cut into 100 cm pieces, and crushed into 10 cm to 20 cm pieces by a double-shaft shredmaster, and a 30% by mass sodium hydroxide solution was added thereto, and the immersion was conducted at 80° C. for 10 min, where a mass ratio of the pieces to the sodium hydroxide solution was 1:10; and a resulting mixture was then subjected to microwave treatment at 1,000 W and 50° C. for 20 min to obtain a material A.
(2) The material A obtained in step (1) was placed into a 100 L steam explosion reactor and treated at a pressure of 2.8 MPa for 5 min, followed by filtering to obtain a material B, and a filtrate which was recycled and used in step (1).
(3) The material B obtained in step (2) was added into a concentrated sulfuric acid solution with a mass fraction of 95% (a mass ratio of the material B to the concentrated sulfuric acid solution was 1:13), and a resulting mixture was subjected to microwave heating at 180° C. and 600 W for 20 min, and followed by filtration, to obtain fibers and organic waste acid.

### Example 4

This example provided a recycling method of a waste fiber-reinforced composite, which differed from Example 1 only in that a solution for immersion in step (1) was 1% sulfuric acid, while the other steps and parameters were the same as those in Example 1.

### Example 5

This example provided a recycling method of a waste fiber-reinforced composite, which differed from Example 1 only in that a mass ratio of the pieces to the sodium hydroxide solution in step (1) was 1:1, while the other steps and parameters were the same as those in Example 1.

### Example 6

This example provided a recycling method of a waste fiber-reinforced composite, which differed from Example 1 only in that a mass ratio of the pieces to the sodium hydroxide solution in step (1) was 1:15, while the other steps and parameters were the same as those in Example 1.

### Example 7

This example provided a recycling method of a waste fiber-reinforced composite, which differed from Example 1 only in that the microwave treatment in step (1) was conducted at a power of 50 W, while the other steps and parameters were the same as those in Example 1.

### Example 8

This example provided a recycling method of a waste fiber-reinforced composite, which differed from Example 1 only in that the microwave treatment in step (1) was conducted at a power of 2,500 W, while the other steps and parameters were the same as those in Example 1.

### Example 9

This example provided a recycling method of a waste fiber-reinforced composite, which differed from Example 1 only in that the steam explosion in step (2) was conducted at a pressure of 0.15 MPa, while the other steps and parameters were the same as those in Example 1.

### Example 10

This example provided a recycling method of a waste fiber-reinforced composite, which differed from Example 1 only in that the steam explosion in step (2) was conducted at a pressure of 5 MPa, while the other steps and parameters were the same as those in Example 1.

### Example 11

This example provided a recycling method of a waste fiber-reinforced composite, which differed from Example 1 only in that a mass ratio of the material B to the concentrated sulfuric acid solution in step (3) was 1:1, while the other steps and parameters were the same as those in Example 1.

### Example 12

This example provided a recycling method of a waste fiber-reinforced composite, which differed from Example 1 only in that a mass ratio of the material B to the concentrated sulfuric acid solution in step (3) was 1:14.5, while the other steps and parameters were the same as those in Example 1.

### Example 13

This example provided a recycling method of a waste fiber-reinforced composite, which differed from Example 1 only in that the microwave heating in step (3) was conducted at a power of 800 W, while the other steps and parameters were the same as those in Example 1.

### Example 14

This example provided a recycling method of a waste fiber-reinforced composite, which differed from Example 1 only in that the concentrated sulfuric acid solution in step (3) had a mass fraction of 58%, while the other steps and parameters were the same as those in Example 1.

### Comparative Example 1

This comparative example provided a recycling method of a waste fiber-reinforced composite, which differed from Example 1 only in that the microwave treatment in step (1) was omitted, while the other steps and parameters were the same as those in Example 1.

### Comparative Example 2

This comparative example provided a recycling method of a waste fiber-reinforced composite, which differed from Example 1 only in that the microwave heating in step (3) was omitted, while the other steps and parameters were the same as those in Example 1.

Performance testing
(1) The fiber recovery rate was calculated according to the following equation: fiber recovery rate=fiber mass finally obtained/fiber mass in fiber-reinforced composite of waste wind turbine blades*100%.
(2) Average fiber diameter: diameters of different fibers were measured using scanning electron microscopy (SEM).
(3) Average fiber tensile strength and average fiber tensile modulus: the test was conducted in accordance with “Carbon fiber-Determination of the tensile properties of single-filament specimens” in GB/T31290-2014; the same sample was measured three times and an average was taken.

Test results were shown in Table 1:

TABLE 1

| | | | Average | Average |
|---|---|---|---|---|
| | Fiber | Average | fiber | fiber |
| | recovery | fiber | tensile | tensile |
| | rate | diameter | strength | modulus |
| | (%) | (μm) | (GPa) | (GPa) |
| Example 1 | 99.50 | 14.60 | 1.19 | 58.3 |
| Example 2 | 99.10 | 14.17 | 1.13 | 57.9 |
| Example 3 | 99.40 | 14.01 | 1.10 | 57.2 |
| Example 4 | 98.60 | 13.86 | 1.06 | 57.1 |
| Example 5 | 91.90 | 14.01 | 1.11 | 57.6 |
| Example 6 | 98.00 | 13.95 | 1.09 | 57.2 |
| Example 7 | 68.10 | 14.15 | 1.12 | 58.1 |
| Example 8 | 98.60 | 13.45 | 1.04 | 56.7 |
| Example 9 | 78.40 | 13.81 | 1.08 | 57.1 |
| Example 10 | 99.10 | 13.95 | 1.09 | 57.8 |
| Example 11 | 89.40 | 13.56 | 1.05 | 56.1 |
| Example 12 | 98.20 | 14.30 | 1.10 | 57.8 |
| Example 13 | 77.40 | 13.67 | 1.01 | 55.9 |
| Example 14 | 67.50 | 14.10 | 1.13 | 57.01 |
| Comparative | 52.40 | 15.61 | 1.04 | 56.75 |
| Example 1 | | | | |
| Comparative | 34.60 | 15.77 | 1.09 | 57.37 |
| Example 2 | | | | |

As shown in the above table, the recycling method according to the present disclosure realizes the rapid separation of fibers and resin material through the synergy of mechanical treatment, steam explosion, and chemical treatment in a specific process. The recycling method reduces reaction steps and energy consumption, and realizes the resource recycling of carbon fiber composites at low cost. As shown in Examples 1 to 3, the recycling method enables the fiber recovery rate to be 99.1% to 99.5%, the average fiber tensile strength to be 1.1 GPa to 1.19 GPa, and the average fiber tensile modulus to be 57.2 GPa to 58.3 GPa.

As shown by comparing Example 1 with Examples 4 to 14, when the chemical reagent is changed, the microwave treatment power or the ratio of the material to the chemical reagent is not within a specific range, the fiber recovery rate decreases to varying degrees.

As shown by comparing Example 1 with Comparative Examples 1 and 2, the fiber recovery rates when no microwave treatment is conducted in step (1) or step (3) decreases to varying degrees.

In summary, the recycling method of a waste fiber-reinforced composite according to the present disclosure realizes the rapid separation of fibers and resin material by a specific process. The recycling method reduces reaction steps and energy consumption, and realizes the resource recycling of carbon fiber composites at low cost. The recycling method has the advantages of simple operations, low energy consumption, wide application range, and significant economic and environmental benefits.

The objectives, technical solutions, and beneficial effects of the present disclosure are described in detail in the above specific examples. It should be understood that the above are merely specific examples of the present disclosure, but are not intended to limit the present disclosure. Any modifications, equivalent replacements, or improvements made within the spirit and principle of the present disclosure shall fall within the scope of the present disclosure.

What is claimed is:

1. A recycling method of a waste fiber-reinforced composite, comprising:
(1) subjecting the waste fiber-reinforced composite to crushing, then immersion, and then a microwave treatment to obtain a material A;
(2) subjecting the material A obtained in step (1) to steam explosion to obtain a material B; and
(3) subjecting the material B obtained in step (2) to a chemical treatment to obtain a recycled material.

2. The recycling method as claimed in claim 1, wherein the crushing in step (1) comprises at least one selected from the group consisting of crushing by cutting and crushing by using a shredmaster.

3. The recycling method as claimed in claim 1 or 2, wherein a solution for the immersion in step (1) is one selected from the group consisting of water, an alkaline solution, and an acidic solution, more optionally the alkaline solution;
optionally, the alkaline solution and the acidic solution each independently have a mass fraction of 0.1% to 70%;
optionally, a mass ratio of the waste fiber-reinforced composite to the solution during the immersion in step (1) is in a range of 1:2 to 1:10;
optionally, the immersion in step (1) is conducted for 10 minutes to 120 minutes; and
optionally, the immersion in step (1) is conducted at a temperature of 20° C. to 90° C.

4. The recycling method as claimed in any one of claims 1 to 3, wherein the microwave treatment in step (1) is conducted at a power of 100-2,000 W per kg of the waste fiber-reinforced composite;
optionally, the microwave treatment in step (1) is conducted at a temperature of 30° C. to 200° C.; and
optionally, the microwave treatment in step (1) is conducted for 1 minute to 60 minutes.

5. The recycling method as claimed in any one of claims 1 to 4, wherein a device for the steam explosion in step (2) is a steam explosion reactor;
optionally, the steam explosion in step (2) is conducted at a pressure of 0.2 MPa to 4 MPa, more optionally 1.5 MPa to 3 MPa; and
optionally, the steam explosion in step (2) is conducted for 1 minute to 20 minutes.

6. The recycling method as claimed in any one of claims 1 to 5, wherein the chemical treatment in step (3) is conducted with a chemical solvent;
optionally, the chemical solvent comprises at least one selected from the group consisting of an acidic solution, an alkaline solution, a boron halide, an alcohol, and an ionic liquid, more optionally the acidic solution;
optionally, the acidic solution comprises at least one selected from the group consisting of sulfuric acid, waste sulfuric acid, formic acid, acetic acid, boric acid, phosphoric acid, nitric acid, hydrofluoric acid, hydrogen peroxide, and hydrochloric acid, and more optionally the sulfuric acid; and
optionally, the alcohol comprises at least one selected from the group consisting of methanol, ethanol, propanol, butanol, ethylene glycol, and octanol.

7. The recycling method as claimed in claim 6, wherein the chemical solvent has a mass fraction of not less than 75%; and
optionally, a mass ratio of the material B to the chemical solvent in step (3) is in a range of 1:2 to 1:100, more optionally 1:2 to 1:13.5.

8. The recycling method as claimed in any one of claims 1 to 7, wherein the chemical treatment in step (3) further comprises mixing the material B with a chemical solvent, and heating;
optionally, the heating comprises microwave heating;
optionally, the microwave heating is conducted at a temperature of 80° C. to 200° C.;
optionally, the microwave heating is conducted for 5 minutes to 300 minutes; and
optionally, the microwave heating is conducted at a power of 10-1,500 W per kg of the material B, more optionally 300-600 W per kg of the material B.

9. The recycling method as claimed in any one of claims 1 to 8, wherein the fiber-reinforced composite comprises at least one selected from the group consisting of a carbon fiber-reinforced composite, a glass fiber-reinforced composite, and a basalt fiber-reinforced composite; and
optionally, a matrix resin in the fiber-reinforced composite comprises at least one selected from the group consisting of a thermosetting resin and a thermoplastic resin.

10. The recycling method as claimed in any one of claims 1 to 9, comprising:
(1) subjecting the waste fiber-reinforced composite to the crushing, then the immersion in a solution at a temperature of 20° C. to 90° C. for 10 minutes to 120 minutes, and then the microwave treatment at a power of 10-2,000 W per kg of the waste fiber-reinforced composite and a temperature of 30° C. to 200° C. for 10 minutes to 60 minutes to obtain the material A, wherein a mass ratio of the waste fiber-reinforced composite to the solution is in a range of 1:2 to 1:10;
(2) subjecting the material A obtained in step (1) to the steam explosion at a pressure of 0.2 MPa to 4 MPa for 1 minute to 20 minutes to obtain the material B; and
(3) mixing the material B obtained in step (2) with a chemical solvent having a mass fraction not less than 75% and then subjecting a resulting mixture to microwave heating at a power of 10-1,500 W per kg of the material B and a temperature of 80° C. to 200° C. for 5 minutes to 300 minutes, to obtain the recycled material, wherein a mass ratio of the material B to the chemical solvent is in a range of 1:2 to 1:100.
